(19) United States
(12) Patent Application Publication
(10) Pub. No.: US 2024/0320491 A1
(43) Pub. Date: Sep. 26, 2024

(54) INFERENCE METHOD AND DEVICE USING DYNAMIC PRUNING FILTER IN CONVOLUTIONAL NEURAL NETWORK MODEL, AND METHOD FOR TRAINING CONVOLUTIONAL NEURAL NETWORK MODEL

(71) Applicant: Research & Business Foundation SUNGKYUNKWAN UNIVERSITY, Suwon-si (KR)

(72) Inventors: Simon Sungil WOO, Suwon-si (KR); Gwang Han LEE, Suwon-si (KR); Sae Byeol SHIN, Suwon-si (KR)

(73) Assignee: Research & Business Foundation SUNGKYUNKWAN UNIVERSITY, Suwon-si (KR)

(21) Appl. No.: 18/613,332

(22) Filed: Mar. 22, 2024

(30) Foreign Application Priority Data
Mar. 23, 2023 (KR) 10-2023-0038133

(51) Int. Cl. G06N 3/082; G06V 10/82

(52) U.S. Cl. CPC G06N 3/082; G06V 10/82

(57) ABSTRACT

There is an inference method using a dynamic pruning filter in a convolutional neural network model. The inference method comprises generating an attention weight matrix based on a feature map of at least one channel extracted from an input image; generating at least one mask matrix by referring to a convolution kernel included in the convolutional neural network model; and outputting the a dynamic pruning filter based on the operation of the attention weight matrix and the at least one mask matrix.

This work was supported by Institute of Information & communications Technology Planning & Evaluation (IITP) grant funded by Korea government (MSIT) (Research and Development of AI Platforms to Flexibly Adapt to and Comply with Changes in Privacy policy (No. 2022-0-00688) and Convergence Security Graduate School (Sungkyunkwan University) Support Project (No. 2022-0-01199)).

### CROSS-REFERENCE TO RELATED APPLICATION

This application claims the benefit under 35 USC 119(a) of Korean Patent Application No. 10-2023-0038133, filed with the Korean Intellectual Property Office on Mar. 23, 2023, the disclosure of which is incorporated herein by reference in its entirety.

### TECHNICAL FIELD

The present disclosure relates to an inference method that employs a dynamic pruning filter in a convolutional neural network model and an inference device that performs the method.

### BACKGROUND

Pruning is one of the techniques for optimizing a deep learning model, which reduces computational load and memory usage of the deep learning model by reducing the size of the deep learning model through removal of unnecessary weights. Because pruning may contribute to generating a deep learning model with a faster inference speed and reduced memory usage, various methods are being studied to advance pruning techniques.

However, conventional pruning techniques may be broadly divided into static pruning and dynamic pruning. A typical static pruning technique that performs consistent operations on all input samples may improve the computational speed of a deep learning model by using a fixed pattern regardless of the input; however, the performance of the deep learning model may be significantly decreased depending on the input samples.

Meanwhile, the dynamic pruning technique is a method that involves removal of weights using different sparse patterns depending on the input samples; the dynamic pruning technique may improve the performance of a deep learning model compared to the static pruning technique; since most of dynamic sparse patterns cause overhead problems such as inefficient path indexing and weight duplication for all input samples, the dynamic pruning technique still encounters a limitation in significantly reducing the computation load and memory usage of deep learning models.

Therefore, to facilitate the inference speed of deep learning models, there is a need to develop a method capable of maintaining performance while reducing the amount of computations of deep learning models.

### SUMMARY

In view of the above, the present disclosure provides an inference method that employs a dynamic pruning filter, which generates an attention weight matrix based on a feature map of at least one channel extracted from an input image, generates at least one mask matrix by referring to a convolution kernel included in the convolutional neural network model, and outputs a dynamic pruning filter based on the operations using the attention weight matrix and the at least one mask matrix.

The technical objects of the present disclosure are not limited to those described above, and other technical objects not mentioned above may be understood clearly by those skilled in the art from the descriptions given below.

In accordance with an aspect of the present disclosure, there is provided an inference method using a dynamic pruning filter in a convolutional neural network model, the method comprises: generating an attention weight matrix based on a feature map of at least one channel extracted from an input image; generating at least one mask matrix by referring to a convolution kernel included in the convolutional neural network model; and outputting the dynamic pruning filter based on the operation of the attention weight matrix and the at least one mask matrix.

Additionally, the generating of the attention weight matrix may include determining importance of the at least one channel based on an average value of the at least one channel determined through global average pooling (GAP); and generating the attention weight matrix based on the importance of the at least one channel.

Additionally, the generating of the at least one mask matrix may include generating the at least one mask matrix by performing static pruning on the weight matrix of the convolution kernel.

Additionally, the generating of the at least one mask matrix may include calculating a difference between each element of the weight matrix of the convolution kernel and a pre-determined threshold value; determining a binarized value for each element by applying a binary step function to the difference; and generating the at least one mask matrix based on the binarized value for each element.

Additionally, the outputting of the dynamic pruning filter may include performing element-wise multiplication on the weight matrix of the convolution kernel, the at least one mark matrix, and the attention weight matrix; and outputting the dynamic pruning filter based on the element-wise multiplication.

Additionally, the inference method further comprises performing inference for image detection or image classification using the dynamic pruning filter.

In accordance with another aspect of the present disclosure, there is provided a inference device using a dynamic pruning filter in a convolutional neural network model, the device comprises: a memory configured to store one or more instructions; and a processor configured to execute the one or more instructions stored in the memory, wherein the instructions, when executed by the processor, cause the processor to: generate an attention weight matrix based on a feature map of at least one channel extracted from an input image; generate at least one mask matrix by referring to a convolution kernel included in the convolutional neural network model; and output the dynamic pruning filter based on the operation of the attention weight matrix and the at least one mask matrix.

Additionally, the processor may be configured to determine importance of the at least one channel based on an average value of the at least one channel determined through global average pooling (GAP); and generate the attention weight matrix based on the importance of the at least one channel.

Additionally, the processor may be configured to generate the at least one mask matrix by performing static pruning on the weight matrix of the convolution kernel.

Additionally, the processor may be configured to calculate a difference between each element of the weight matrix of the convolution kernel and a pre-determined threshold value; determine a binarized value for each element by applying a binary step function to the difference; and generate the at least one mask matrix based on the binarized value for each element.

Additionally, the processor may be configured to perform element-wise multiplication on the weight matrix of the convolution kernel, the at least one mark matrix, and the attention weight matrix; and output the dynamic pruning filter based on the element-wise multiplication.

Additionally, the processor may be configured to perform inference for image detection or image classification using the dynamic pruning filter.

In accordance with another aspect of the present disclosure, there is provided a non-transitory computer storage medium storing computer executable instructions, wherein the instructions, when executed by a processor, cause the processor to perform an inference method using a dynamic pruning filter in a convolutional neural network model, the method comprise: generating an attention weight matrix based on a feature map of at least one channel extracted from an input image; generating at least one mask matrix by referring to a convolution kernel included in the convolutional neural network model; and outputting the dynamic pruning filter based on the operation of the attention weight matrix and the at least one mask matrix.

In accordance with another aspect of the present disclosure, there is provided a computer program including computer executable instructions stored in a non-transitory computer storage medium, wherein the instructions, when executed by a processor, cause the processor to perform an inference method using a dynamic pruning filter in a convolutional neural network model, the method comprise: generating an attention weight matrix based on a feature map of at least one channel extracted from an input image; generating at least one mask matrix by referring to a convolution kernel included in the convolutional neural network model; and outputting the dynamic pruning filter based on the operation of the attention weight matrix and the at least one mask matrix.

In accordance with another aspect of the present disclosure, there is provided a method for training a convolutional neural network model for a use in an electronic device including a memory and a processor, the method comprise: preparing training data including training input images and training label data including a dynamic pruning filter; inputting the training input images to the convolutional neural network model; training the convolutional neural network model by generating an attention weight matrix based on a feature map of at least one channel extracted from the training input images; generating at least one mask matrix by referring to a convolution kernel included in the convolutional neural network model; and outputting the dynamic pruning filter, which is the training label data, based on the operation of the attention weight matrix and the at least one mask matrix.

According to an embodiment of the present disclosure, since image detection or image classification is performed using a dynamic pruning filter, performance of a neural network model may be maintained while computational loads are reduced.

Also, according to an embodiment of the present disclosure, since a dynamic pruning filter reduces the computational load of a deep learning model and enables inference in IoT devices such as mobile devices, real-time detection such as detection of abnormal behavior through CCTV may be achieved.

Also, according to an embodiment of the present disclosure, unlike existing dynamic pruning techniques, by fusing patterns of various convolution kernels, expressiveness may be improved, and hardware efficiency may be maintained.

### BRIEF DESCRIPTION OF THE DRAWINGS

FIG. 1 is a block diagram illustrating an inference apparatus that employs a dynamic pruning filter according to an embodiment of the present disclosure.

FIG. 2 is a block diagram conceptually illustrating the function of a neural network model inference program according to one embodiment of the present disclosure.

FIG. 3 is a flow diagram illustrating an inference method that employs a dynamic pruning filter according to one embodiment of the present disclosure.

FIG. 4 illustrates an exemplary process of outputting a dynamic pruning filter according to one embodiment of the present disclosure.

FIG. 5 illustrates an exemplary operation for outputting a dynamic pruning filter according to one embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

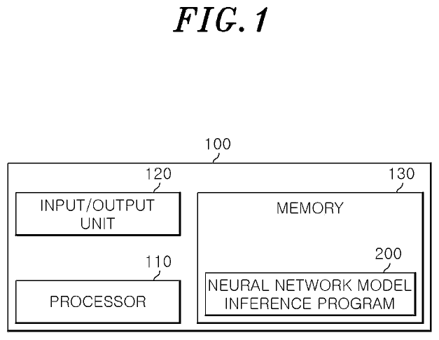

Referring to FIG. 1, the neural network model inference apparatus 100 may comprise a processor 110, an input/output device 120, and a memory 130.

The processor 110 may control the overall operation of the neural network model inference apparatus 100.

The processor 110 may receive an image and at least one feature map from among feature maps of at least one channel extracted from the image using the input/output device 120.

In the present disclosure, it is assumed that the image and at least one feature map from among feature maps of at least one channel extracted from the image are received through the input/output device 120, but the present disclosure is not limited to the specific assumption. In other words, depending on the embodiments, the neural network model inference apparatus 100 may include a transceiver (not shown), the neural network model inference apparatus 100 may use the transceiver (not shown) to receive the image and at least one feature map from among feature maps of at least one channel extracted from the image, and the feature map of at least one channel extracted from the image may be generated within the neural network model inference apparatus 100.

Here, the feature map of at least one channel extracted from the image is an activation map related to the features extracted by inputting the image to the convolutional neural network model, and the feature map may refer to the result obtained after the image passes through the convolution layer (or multiplication layer) of the convolutional neural network model.

The processor 110 may generate an attention weight matrix based on a feature map of at least one channel extracted from the input image, generate at least one mask matrix by referring to a convolution kernel included in the convolutional neural network model, and output a dynamic pruning filter based on the operation of the attention weight matrix and at least one mask matrix.

Also, the processor 110 may perform inference for image detection or image classification using the dynamic pruning filter.

The input/output device 120 may include one or more input devices and/or one or more output devices. For example, the input device may include a microphone, a keyboard, a mouse, and a touch screen; the output device may include a display and a speaker.

The memory 130 may store the neural network model inference program 200 and information required for executing the neural network model inference program 200.

The neural network model inference program 200 according to the present disclosure may refer to the software that includes instructions for receiving an image and outputting a dynamic pruning filter.

To execute the neural network model inference program 200, the processor 110 may load the neural network model inference program 200 and information required for executing the neural network model inference program 200 from the memory 130.

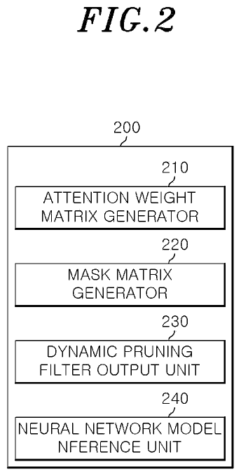

The functions and/or operations of the neural network model inference program 200 will be described in detail with reference to FIG. 2.

FIG. 2 is a block diagram conceptually illustrating the function of a neural network model inference program according to one embodiment of the present disclosure.

Referring to FIG. 2, the neural network model inference program 200 may include an attention weight matrix generator 210, a mask matrix generator 220, a dynamic pruning filter output unit 230, and a neural network model output unit 240.

The attention weight matrix generator 210, the mask matrix generator 220, the dynamic pruning filter output unit 230, and the neural network model output unit 240 shown in FIG. 2 conceptually divide the functions of the neural network model inference program 200 for the purpose of describing the functions of the neural network model inference program 200, but the present disclosure is not limited to the specific structure. Depending on the embodiments, the functions of the attention weight matrix generator 210, the mask matrix generator 220, the dynamic pruning filter output unit 230, and the neural network model output unit 240 may be merged/separated, or the functions may be implemented using a series of instructions included in one program.

First, the attention weight matrix generator 210 may generate an attention weight matrix based on a feature map of at least one channel extracted from an input image.

Here, a feature map of at least one channel extracted from an input image comprises output values obtained through a convolution operation (or multiplication operation) on the input image in a convolutional neural network model, which may express features extracted from the image of at least one channel (e.g., an RGB channel).

Specifically, the convolution operation refers to the operation of sliding a small filter, called a kernel, across the input image, multiplying the filer elements to the corresponding values of the image area covered by the filter window at each sliding position, and calculating an output value by summing all the resulting product values; a feature map may refer to the collection of output values calculated through the convolution operation.

Meanwhile, the attention weight matrix generator 210 may determine the importance of at least one channel based on the average value of at least one channel determined through global average pooling (GAP).

Specifically, the attention weight matrix generator 210 may compress the amount of information within at least one channel by calculating the average value of each channel by applying GAP to the feature map. Also, the attention weight matrix generator 210 may determine the importance of at least one channel based on their respective average values.

Also, the attention weight matrix generator 210 may generate an attention weight matrix based on the importance of at least one channel.

Specifically, the attention weight matrix generator 210 may estimate at least one inter-channel dependency based on the importance of each channel determined from the average values of the respective channels and determine the weights of the respective channels by considering the inter-channel dependency. The attention weight matrix generator 210 may generate an attention weight matrix by considering the weights.

Next, the mask matrix generator 220 may generate at least one mask matrix by referring to a convolution kernel included in the convolutional neural network model.

Here, a convolution kernel is a filter used for the convolution operation, which builds a feature map by performing an operation on a specific portion of an input image as the convolution kernel slides across the input image. For example, the convolution kernel may have a specific pattern corresponding to the weight matrix of the convolution kernel and may be used for the operation with a specific portion of an image according to the pattern.

Specifically, the mask matrix generator 220 may generate at least one mask matrix by performing static pruning on the weight matrix of the convolution kernel.

Here, static pruning may refer to the technique for lightweighting a neural network model, which reduces the amount of computation by distinguishing the importance of individual weights in the weight matrix of a convolution kernel, applying the same convolution operation regardless of the input image, and pruning a channel or a filter deemed to be insignificant in the neural network model.

For example, static pruning techniques include element-wise pruning, channel-wise pruning, stripe-wise pruning, and filter-wise pruning.

Element-wise pruning according to one embodiment of the present disclosure may refer to pruning based on a weight matrix with an irregular sparse pattern, channel-wise pruning may refer to pruning multiple adjacent columns in the extended weight matrix, stripe-wise pruning may refer to pruning weights at the same position in different convolution filters, and filter-wise pruning may refer to pruning multiple rows of the extended weight matrix.

In other words, the mask matrix generator 220 may perform static pruning to generate a mask matrix corresponding to p patterns. Through the operation above, static pruning is performed to have p patterns, thereby achieving the effect of accelerating the convolution operation of the convolutional neural network model.

Meanwhile, the mask matrix generator 220 may calculate the difference from a predefined threshold for each element of the weight matrix of the convolution kernel. Here, the predefined threshold may vary depending on the static pruning techniques.

For example, the mask matrix generator 220 may determine the difference from the predefined threshold value for each element of the weight matrix of the convolution kernel by converting the initial difference into a value of 0 and 1 using a sigmoid function and further calculating the difference of the sigmoid function's output from 0.5.

Also, the mask matrix generator 220 may determine a binarized value for each element by applying a binary step function to the difference values obtained. Specifically, the mask matrix generator 220 may determine each component to be 0 or 1 through the binary step function. For example, the mask matrix generator 220 may determine an element to be 0 when the difference is a negative number and determine an element to be 1 when the difference is 0 or a positive number.

Also, the mask matrix generator 220 may generate at least one mask matrix based on the binarized value for each element. Through the operation above, the elements of at least one mask matrix are determined to be 0 or 1, and at least one mask matrix with a specific pattern may be generated.

Meanwhile, the at least one mask matrix may be expressed by Eq. 1 below.

$${M}_{i} = H ( σ ( \vert {W}_{ij} \vert - {T}_{ij} ) - 0.5 ) \qquad [ Eq . 1 ]$$

In Eq. 1, Mᵢ may represent a mask matrix, Wᵢⱼ may represent a weight matrix of the convolution kernel, Tᵢⱼ may represent a predefined threshold for specifying a pattern of the convolution kernel, a may represent an activation function, which may be the sigmoid function, and H(x) may represent a binary step function.

Next, the dynamic pruning filter output unit 230 may output a dynamic pruning filter based on the operation of the attention weight matrix and at least one mask matrix.

Specifically, the dynamic pruning filter output unit 230 may perform element-wise multiplication on the weight matrix of the convolution kernel, at least one mask matrix, and the attention weight matrix.

For example, the dynamic pruning filter output unit 230 may generate at least one pruned weight matrix by first performing element-wise multiplication between at least one mask matrix and the weight matrix of the convolution kernel. Next, the dynamic pruning filter output unit 230 may perform element-wise multiplication on the pruned weight matrix and the attention weight matrix.

Specifically, if the number of patterns corresponding to the at least one mask matrix is p, element-wise multiplication on the pruned weight matrix and the attention weight matrix may be performed p times.

Also, the dynamic pruning filter output unit 230 may output the dynamic pruning filter based on the element-wise multiplication.

Specifically, when the number of patterns corresponding to at least one mask matrix is p, element-wise multiplication may be performed p times on the pruned weight matrix and the attention weight matrix, and the dynamic pruning filter output unit 230 may output the dynamic pruning filter by performing an addition operation on the values obtained from the element-wise multiplication performed p times.

Next, the neural network model inference unit 240 may perform inference for image detection or image classification using the dynamic pruning filter.

Also, the neural network model inference unit 240 may not only perform image detection and image classification using the dynamic pruning filter in a convolutional neural network model but also perform inference for computer vision tasks such as video classification and video tracking.

Meanwhile, the convolutional neural network model according to one embodiment of the present disclosure may be trained based on a loss function for outputting a dynamic pruning filter from an input image.

For example, the loss function may include a first loss function considering the cross-entropy loss and a second loss function considering a threshold value for specifying a pattern of the convolution kernel due to static pruning.

Meanwhile, the loss function L may be expressed by Eq. 2 below.

$$\begin{matrix}L = {L}_{CE} + α {L}_{reg} \\ {L}_{reg} = {\sum }_{k = 1}^{L} {\sum }_{j = 1}^{N} {\sum }_{i = 1}^{P} exp ( - {T}_{ijk} )\end{matrix} \qquad [ Eq . 2 ]$$

In Eq. 2, L_{CE} may represent the first loss function, L_{reg} may represent the second loss function, and a may represent a hyper-parameter. Also, L may represent the number of layers of the convolutional neural network model, N may represent the number of convolution filters, P may represent the number of patterns of the convolution kernel determined through static pruning, and T may represent the threshold value according to static pruning.

Specifically, since the convolutional neural network model is trained through back-propagation to minimize the loss function, the convolutional neural network may receive an image as input and output a dynamic pruning filter. Also, through adjustment of the hyper-parameter, training is carried out in the direction that the threshold value becomes relatively large or small, and a pattern corresponding to at least one mask matrix may be determined.

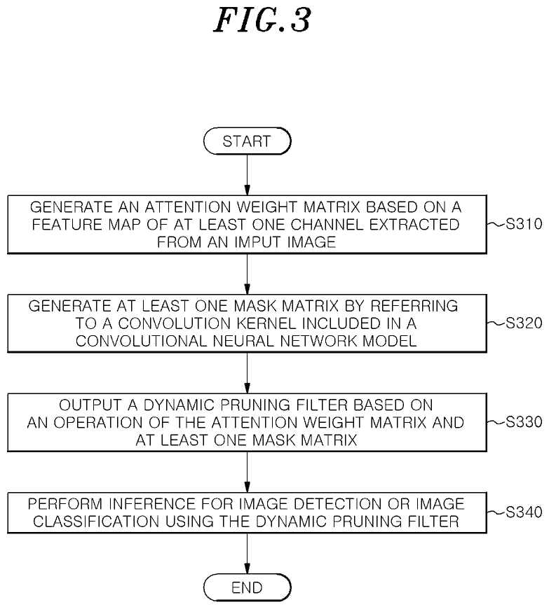

FIG. 3 is a flow diagram illustrating an inference method that employs a dynamic pruning filter according to one embodiment of the present disclosure.

Referring to FIGS. 2 and 3, the attention weight matrix generator 210 may generate an attention weight matrix based on a feature map of at least one channel extracted from an input image S310, generate at least one mask matrix by referring to the convolution kernel included in the convolutional neural network model S320, and output a dynamic pruning filter based on the operation of the attention weight matrix and at least one mask matrix S330; the neural network model output unit 240 may perform inference for image detection or image classification using the dynamic pruning filter.

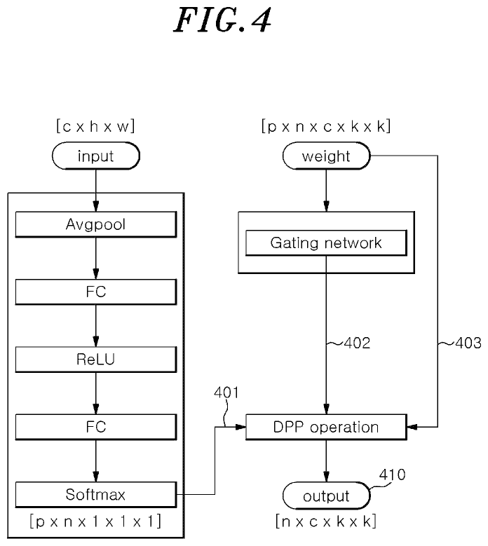

FIG. 4 illustrates an exemplary process of outputting a dynamic pruning filter according to one embodiment of the present disclosure.

Referring to FIGS. 2 and 4, an image with dimensions of height h, width w, and c channels may be input to the convolutional neural network model, and feature maps for the c channels may be generated.

Next, the attention weight matrix generator 210 may determine the importance based on the average values of the c channels determined through GAP and generate the attention weight matrix 401 based on the importance of the c channels.

Specifically, the attention weight matrix generator 210 may generate the attention weight matrix 401 using an average pooling layer, two fully connected layers, an activation function, and a Softmax function.

More specifically, an input image may be reformulated as a c×1×1 dimensional matrix using the average polling layer. Also, the attention weight matrix 401 may be formulated as a p×n×1×1×1 dimensional matrix using the two fully connected layers, the relu function, and the Softmax function. The p may refer to the number of patterns of the convolution kernel, and n may refer to the number of output channels.

Also, the mask matrix generator 220 may generate at least one mask matrix 402 by calculating the difference between each element of the weight matrix 403 of the convolution kernel and the predefined threshold and determining a binarized value for each element by applying the binary step function to the difference. Here, the weight matrix 403 of the convolution kernel may refer to the p×n×c×k×k dimensional matrix. The k may refer to the size of the convolution kernel.

Also, the dynamic pruning filter output unit 230 may output the dynamic pruning filter 410 based on the operations of the weight matrix 403 of the convolution kernel, at least one mask matrix 402, and the attention weight matrix 401.

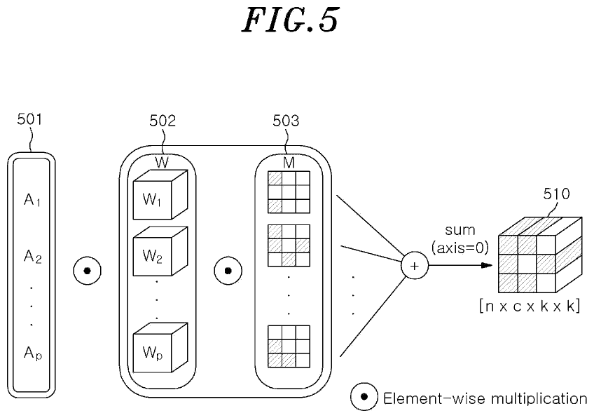

FIG. 5 illustrates an exemplary operation for outputting a dynamic pruning filter according to one embodiment of the present disclosure.

Referring to FIGS. 2 and 5, the dynamic pruning filter output unit 230 may generate at least one pruned weight matrix by first performing element-wise multiplication on the weight matrix 502 of the convolution kernel and at least one mask matrix 503. Then, the dynamic pruning filter output unit 230 may perform element-wise multiplication on the pruned weight matrix and the attention weight matrix 501.

Here, when the number of patterns corresponding to at least one mask matrix is p, element-wise multiplication may be performed p times on the pruned weight matrix and the attention weight matrix, and the dynamic pruning filter output unit 230 may output the dynamic pruning filter 510 by performing an addition operation on the values obtained from the element-wise multiplication performed p times.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. An inference method using a dynamic pruning filter in a convolutional neural network model, the method comprising:
generating an attention weight matrix based on a feature map of at least one channel extracted from an input image;
generating at least one mask matrix by referring to a convolution kernel included in the convolutional neural network model; and
outputting the dynamic pruning filter based on the operation of the attention weight matrix and the at least one mask matrix.

2. The inference method of claim 1, wherein the generating the attention weight matrix includes:
determining importance of the at least one channel based on an average value of the at least one channel determined through global average pooling (GAP); and
generating the attention weight matrix based on the importance of the at least one channel.

3. The inference method of claim 1, wherein the generating the at least one mask matrix includes generating the at least one mask matrix by performing static pruning on the weight matrix of the convolution kernel.

4. The inference method of claim 3, wherein the generating the at least one mask matrix includes:
calculating a difference between each element of the weight matrix of the convolution kernel and a pre-determined threshold value;
determining a binarized value for each element by applying a binary step function to the difference; and
generating the at least one mask matrix based on the binarized value for each element.

5. The inference method of claim 1, wherein the outputting the dynamic pruning filter includes:
performing element-wise multiplication on the weight matrix of the convolution kernel, the at least one mark matrix, and the attention weight matrix; and
outputting the dynamic pruning filter based on the element-wise multiplication.

6. The inference method of claim 1, further comprising:
performing inference for image detection or image classification using the dynamic pruning filter.

7. A inference device using a dynamic pruning filter in a convolutional neural network model, the device comprising:
a memory configured to store one or more instructions; and
a processor configured to execute the one or more instructions stored in the memory, wherein the instructions, when executed by the processor, cause the processor to:
generate an attention weight matrix based on a feature map of at least one channel extracted from an input image;
generate at least one mask matrix by referring to a convolution kernel included in the convolutional neural network model; and
output the dynamic pruning filter based on the operation of the attention weight matrix and the at least one mask matrix.

8. The inference device of claim 7, wherein the processor is configured to
determine importance of the at least one channel based on an average value of the at least one channel determined through global average pooling (GAP); and
generate the attention weight matrix based on the importance of the at least one channel.

9. The inference device of claim 7, wherein the processor is configured to generate the at least one mask matrix by performing static pruning on the weight matrix of the convolution kernel.

10. The inference device of claim 9, wherein the processor is configured to calculate a difference between each element of the weight matrix of the convolution kernel and a pre-determined threshold value;
determine a binarized value for each element by applying a binary step function to the difference; and
generate the at least one mask matrix based on the binarized value for each element.

11. The inference device of claim 7, wherein the processor is configured to
perform element-wise multiplication on the weight matrix of the convolution kernel, the at least one mark matrix, and the attention weight matrix; and
output the dynamic pruning filter based on the element-wise multiplication.

12. The inference device of claim 7, wherein the processor is configured to perform inference for image detection or image classification using the dynamic pruning filter.

13. A method for training a convolutional neural network model for a use in electronic device including a memory and a processor, the method comprising:
preparing training data including training input images and training label data including a dynamic pruning filter;
inputting the training input images to the convolutional neural network model;
training the convolutional neural network model by generating an attention weight matrix based on a feature map of at least one channel extracted from the training input images;
generating at least one mask matrix by referring to a convolution kernel included in the convolutional neural network model; and
outputting the dynamic pruning filter, which is the training label data, based on the operation of the attention weight matrix and the at least one mask matrix.

14. The method of claim 13, wherein training the convolutional neural network model includes:
determining importance of the at least one channel based on an average value of the at least one channel determined through global average pooling (GAP); and
generating the attention weight matrix based on the importance of the at least one channel.

15. The method of claim 13, wherein training the convolutional neural network model includes generating the at least one mask matrix by performing static pruning on the weight matrix of the convolution kernel.

16. The method of claim 13, wherein training the convolutional neural network model includes:
calculating a difference between each element of the weight matrix of the convolution kernel and a pre-determined threshold value;
determining a binarized value for each element by applying a binary step function to the difference; and
generating the at least one mask matrix based on the binarized value for each element.

17. The method of claim 13, wherein training the convolutional neural network model includes:
performing element-wise multiplication on the weight matrix of the convolution kernel, the at least one mark matrix, and the attention weight matrix; and
outputting the dynamic pruning filter based on the element-wise multiplication.
